(19) United States
(12) Patent Application Publication
(10) Pub. No.: US 2012/0264527 A1
(43) Pub. Date: Oct. 18, 2012

(54) DRIVE CABLE CENTERING INSERT

(75) Inventor: Kim B. Liechty, Mt. Juliet, TN (US)

(73) Assignee: YAT ELECTRICAL APPLIANCE COMPANY, LTD, Jiaxing (CN)

(21) Appl. No.: 13/087,783

(22) Filed: Apr. 15, 2011

(51) Int. Cl. F16C 1/26

(52) U.S. Cl. 464/173

(57) ABSTRACT

A drive cable centering insert including a tubular core centered within a plurality of axially coextensive and circumferentially spaced-apart flexible members attached to the core and extending in a direction outward therefrom at a sharp acute angle, each flexible member having a length to cause it to bend when engaged with a coextensive tubular housing. An insert including a tubular core substantially centered within coextensive linear cross members that tangentially engage but do not intersect or extend from the tubular core.

### TECHNICAL FIELD AND BACKGROUND

The present invention relates generally to the field of centering apparatus for rotating drive cables, and more particularly, to inserts for concentrically centering a rotating drive cable of a power tool within a protective tubular housing.

Power tools such as string trimmers commonly utilize a flexible drive cable to transmit torque generated by an engine to a rotating head. In such tools, the head and engine are typically connected by a rugged tubular housing that houses the drive cable. In order to withstand the forces of use and provide durability to the tool, the tubular housing is typically made of metal and has a significant diameter to resist bending. As the drive cable typically has a small outer diameter in comparison to the inner diameter of the tubular housing, a resulting space is formed between the outer diameter of the rotating drive cable and the inner wall of the tubular housing. This resulting space allows an unconstrained drive cable freedom to move and rotate along a non-linear axis, consequentially allowing the rotating drive cable to contact the inner wall of the tubular housing, which can cause damage, premature wear and noise.

Accordingly, inserts have been developed in an attempt to maintain concentric alignment of the drive cable within a tubular housing such that the rotation of the drive cable occurs along a linear axis and the rotating drive cable avoids contact with the inner wall of the housing. Such conventional insert designs either do not maintain the desired concentric relationship, or wear and/or lose resiliency after time and thus only maintain a concentric relationship for a brief period.

### SUMMARY

In one aspect, provided herein are embodiments of drive cable centering inserts for concentrically aligning a rotating drive cable within a tubular housing such that the drive cable rotates along a substantially linear axis and avoids contact with an inner wall of a tubular housing.

In another aspect, the inserts are shaft liners.

According to another aspect, the inserts maintain spacing between a rotating drive cable and an inner wall of a tubular housing.

According to another aspect, the inserts constrain a rotating drive cable.

According to another aspect, the insert includes a tubular core substantially centered within a plurality of resilient members originating from the tubular core and arranged to engage the inner surface of the tubular housing.

According to another aspect, the resilient members are curved and extend from the tubular core at a sharp acute angle with respect thereto.

According to another aspect, the resilient members are elongate fins each having a length greater than a distance between the outer surface of their tubular core and an inner surface of a tubular housing in which the insert is positioned such that the resilient members are forced to bend.

According to another aspect, the insert includes a tubular core substantially centered within linear cross members that engage but do not intersect or extend from the tubular core to engage an inner surface of a tubular housing.

According to another aspect, the insert has a continuous length substantially equal to the length of its respective drive cable.

According to another aspect, multiple inserts are spaced apart along the length of their respective drive cable.

According to another aspect, the inserts are non-metallic.

To achieve the foregoing and other aspects and advantages, in one embodiment a drive cable centering insert is provided herein including a tubular core substantially centered within a plurality of circumferentially spaced-apart resilient members attached to the tubular core and extending in a direction radially outward from the tubular core at a sharp acute angle with respect thereto, each of the resilient members having a length greater than a distance between the tubular member and an inner surface of a tubular housing in which the insert is positioned.

In another embodiment, a drive cable centering insert is provided herein including a tubular core substantially centered within linear cross members that tangentially engage the tubular core but do not intersect or extend from the tubular core.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

Additional features, aspects and advantages of the embodiments are better understood when the following detailed description of the embodiments is read with reference to the accompanying drawings in which:

FIG. 1 illustrates an exemplary power tool suitable for use with drive cable centering inserts provided herein;

FIG. 2 is a perspective view of a drive cable centering insert including a tubular core centered within a plurality of circumferentially-spaced resilient members;

FIG. 3 is a sectional view of the tubular housing of the tool of FIG. 1 showing the insert of FIG. 2 installed therein;

FIG. 4 is a perspective view of an elongate drive cable centering insert including a tubular core centered within linear members that engage but do not intersect or extend from the tubular core; and

FIG. 5 is a sectional view of the tubular housing of the tool of FIG. 1 showing the insert of FIG. 4 installed therein.

### DETAILED DESCRIPTION OF THE EMBODIMENTS

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

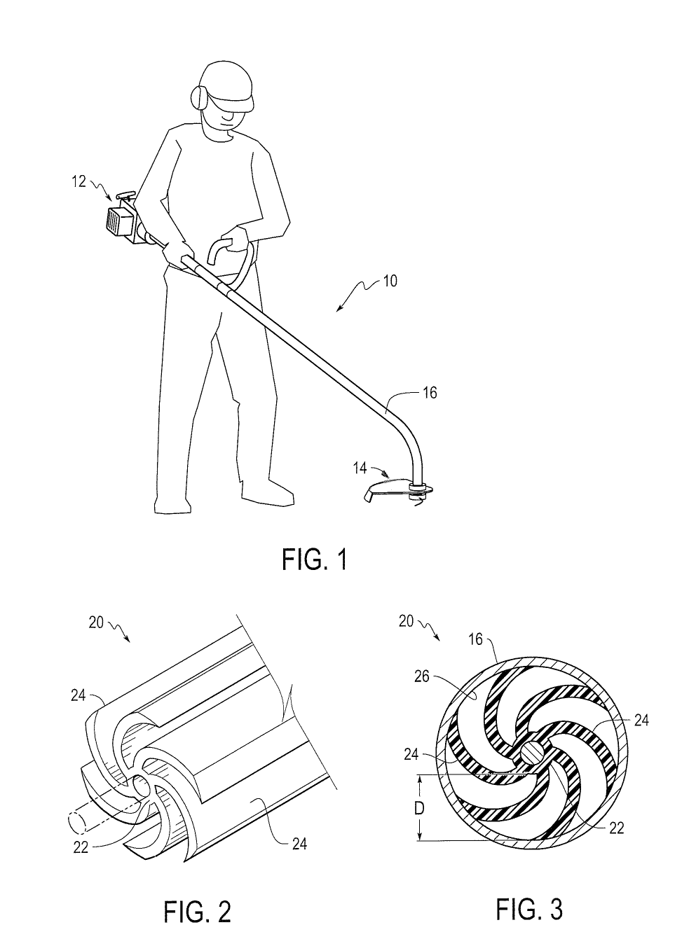

Referring to FIG. 1, an exemplary power tool suitable for use with the drive cable centering insert embodiments provided herein is shown generally at reference numeral 10. Tool 10 generally includes an engine 12 and rotating head 14 interconnected by a tubular housing 16 that maintains a flexible torque-transmitting drive cable therein as known to those in the art. Tubular housing 16 has a length sufficient to balance and space-apart engine 12 and working head 14. Tubular housing 16 can be constructed of rigid material such as metal to protect the maintained drive cable therein. Tubular housing 16 has a diameter and wall thickness sufficient to resist bending and loosely house the drive cable therein. Although the specific power tool shown is a string trimmer, such tool type is provided as an example, and it is intended that the inserts provided herein can be used with any tool, device or apparatus including one member required to be constrained relative to another.

Referring to FIGS. 2-5, the drive cable centering insert embodiments (herein “inserts”) disclosed herein generally function to provide a conduit within a conduit that constrains a drive cable such that the drive cable rotates along a substantially non-helical axis. The inserts also function to urge a rotating drive cable into concentric alignment with a surrounding coextensive tubular housing and/or space the rotating drive cable apart from the inner surface of a surrounding coextensive tubular housing to avoid contact therewith. The inserts thus address the free space intermediate the outer surface of a drive cable and the inner surface of its tubular housing resulting from significant diameter differences between the components. The inserts preferably have a tubular core inner diameter slightly larger than an outer diameter of their installed drive cable in order to laterally constrain the drive cable without hampering the rotation of the drive cable.

The inserts are preferably constructed of non-metallic material, for example polyoelifin or like material, such that at least portions of the inserts are flexible and resilient. Inserts may be coextensive with the drive cable or provided in short lengths as compared to the length of the corresponding drive cable and thus may be positioned at spaced-apart intervals along the length of the drive cable. In an alternative embodiment, the inserts may have a continuous length substantially corresponding to the length of the drive cable, the tubular housing, or both. The inserts can be flexible along their longitudinal axis to facilitate installation within a bent tubular housing as commonly found in string trimmers that bent adjacent the head.

Referring specifically to FIGS. 2 and 3, a first embodiment of a drive cable centering insert is shown generally at reference numeral 20. Insert 20 generally includes an elongate tubular core 22 substantially centered within a plurality of resilient flexible members 24 that extend radially outward in the direction of and engaging an inner surface 26 of a coextensive cylindrical tubular housing 16. Tubular core 22 has a cylindrical cross-section and wall thickness sufficient to constrain the drive cable into rotation along a non-helical, non-spherical, or linear axis in certain embodiments. Flexible members 24 each originate from and extend at a sharp acute angle relative to tubular core 22 such that flexible members 24 are oriented more tangential with respect to tubular core 22 than normal.

Flexible members 24 are circumferentially spaced around the outer surface of tubular core 22, and are preferably equally spaced-apart such that the free ends of flexible members 24 engaging the inner surface of tubular core 22 are equally spaced-apart, thus each applying equal pressure on tubular core 22 to maintain substantially concentric alignment.

Each flexible member 24 has a length greater, and in a specific embodiment significantly greater, than distance “D” defined between the outer surface of tubular core 22 and the inner surface of tubular housing 16 such that each flexible member 24 is forced to bend to a curved shape when installed within tubular housing 24. The length difference and forced bending of flexible members 24 causes the free end of each member to “trail” its respective attached end when viewed along the axial cross-section of tubular core 22. As shown, in one example the length difference results in diametrical opposite positioning of the attached end and the free end with respect to tubular core 22. Flexible members 24 are preferably resilient and biased toward a linear configuration such that the tubular core 22 is biased away from the inner surface of tubular housing 16 when flexible members 24 engage the inner surface and are bent, thus the circumferential array of flexible members 24 urges tubular core 22 toward the axial center of tubular housing 16.

Flexible members 24 can be gradually curved along substantially their entire length such that forces imparted thereto are equally distributed along the length. Each of flexible members 24 can further have a constant cross-sectional thickness. Insert 20 has at least three equally circumferentially spaced-apart flexible members 24, more preferably four flexible members 24, even more preferably more than six flexible members 24. The tubular core 22 and the predetermined number of flexible members 24 can be integral.

Flexible members 24 can be fins extending substantially the length of their tubular core 22 or may have discrete lengths with respect to tubular core 22. Flexible members 24 may be interrupted at locations corresponding with bends of an associated tubular housing 16. Flexible members 24 may be discontinuous and circumferentially shifted with respect to other members at different points along the length of tubular core 22. Insert 20 may also be provided in predetermined lengths such that equally spaced-apart inserts cooperatively constrain the drive cable.

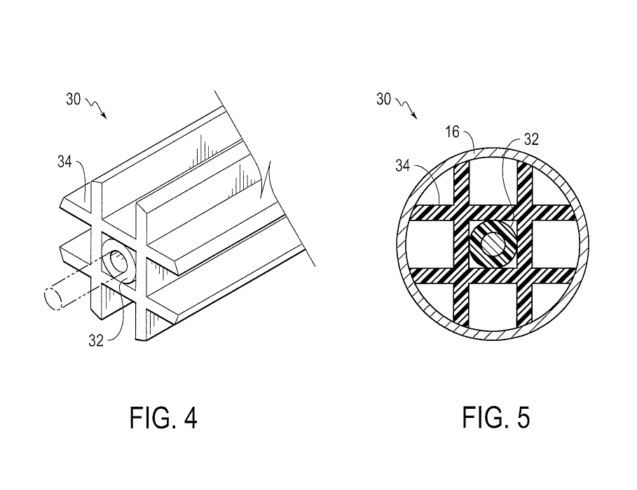

Referring to FIGS. 4 and 5, another embodiment of a drive cable centering insert is shown generally at reference numeral 30. Insert 30 generally includes tubular core 32 centered within a plurality of linear members 34 that tangentially engage but do not intersect or extend from tubular core 32. In the embodiment shown, four linear members tangentially engage tubular core 32 at approximately its 12-o'clock, 3-o'clock, 6-o'clock, and 9-o'clock positions, thus maintaining cylindrical tubular core 32 within a square frame. Each linear member 34 is intersected by two others that are arranged parallel to one another and perpendicular to the linear members that they intersect. Both ends of each linear member 34 thus engages the inner surface of tubular housing 16. Ends of linear members 34 may be perpendicular with respect to their length or at an angle relative thereto. Linear members 34 can extend substantially the axial length of the tubular core 22 or can be spaced-apart in groups along the axial length of tubular core 22.

Although specific embodiments of drive cable centering inserts are disclosed herein, it is envisioned that modifications can be made thereto by those skilled in the art without departing from the spirit and scope of the disclosure.

What is claimed is:

1. A drive cable centering insert, comprising:
a tubular core substantially centered within a plurality of axially coextensive and circumferentially spaced-apart flexible members attached to the tubular core and extending outward from the tubular core at a sharp acute angle, each of the flexible members having a length such that each flexible member bends when engaged with an inner surface of a coextensive tubular housing.

2. The insert according to claim 1, wherein an attached end and a free end of the flexible member are generally diametrically opposed with respect to the tubular core.

3. The insert according to claim 1, wherein the tubular core has a cylindrical cross-section.

4. The insert according to claim 1, wherein each of the flexible members are gradually curved.

5. The insert according to claim 1, wherein each of the flexible members has a constant cross-sectional thickness.

6. The insert according to claim 1, wherein the insert includes at least six equally spaced-apart flexible members attached to the tubular core.

7. The insert according to claim 1, wherein the tubular core and the flexible members are integral.

8. A drive cable centering insert, comprising:
a tubular core substantially centered within coextensive linear cross members that tangentially engage the tubular core but do not intersect or extend from the tubular core.

9. The insert according to claim 8, wherein the insert comprises four perpendicularly intersecting linear members.

10. The insert according to claim 8, wherein each linear member is intersected by two other linear members oriented perpendicular thereto and parallel to one another.

11. The insert according to claim 8, wherein the linear members define a square frame around the tubular core.

12. The insert according to claim 8, wherein the insert comprises four intersecting linear members.

13. The insert according to claim 8, wherein the linear members extend substantially the axial length of the tubular core.

14. The insert according to claim 8, wherein groups of intersecting linear members are spaced apart along the axial length of the tubular core.
